(19) United States
(12) Patent Application Publication
(10) Pub. No.: US 2012/0173997 A1
(43) Pub. Date: Jul. 5, 2012

(54) SYSTEM AND METHOD FOR CAPTURING A STATE OF A RUNNING APPLICATION

(75) Inventors: Richard S. Schwerdtfeger, Round Rock, TX (US); Michael A. Squillace, Austin, TX (US)

(73) Assignee: International Business Machines Corporation, Armonk, NY (US)

(21) Appl. No.: 12/982,735

(22) Filed: Dec. 30, 2010

(51) Int. Cl. G06F 3/048

(52) U.S. Cl. 715/762

(57) ABSTRACT

Exemplary embodiments disclose a method and system for providing a runtime state of an application on a user interface. The method and system include rendering a user interface element on the user interface in response to a request for a capture of the runtime state of the application. The method and system also include generating control code for managing a response of the user interface element to the user action. The user interface element corresponds to the runtime state and to data including at least one of control data and inaccessible data. The control data corresponds to control of the user interface element. The inaccessible data corresponding to a portion of the user interface element not depicted on the user interface for the capture.

### BACKGROUND

Screenshots are frequently used in developing and using software applications. A screenshot is a bitmap image taken by a computer of the running application. Screenshots thus record the visible items of the display device at the time of the snapshot. To this extent, a screenshot records the runtime state of the application. Typically, screenshots are used to assist users in learning to use an application, to help developers diagnose a problem with an application, and to demonstrate features or functionality of an application. Further, many operating systems include functions that can be activated by the user to capture a screenshot or series of screenshots. Thus, screenshots are a readily available tool for use in software development and use.

Although screenshots are useful, they suffer from several drawbacks. As a screenshot is a bitmap image, the screen shot only provides a picture of the visible components, controls, and items at the time the screenshot was taken. The screenshot does not provide significant information for inaccessible data. Inaccessible data includes information related to the runtime state of the application that is not visible at the time of capture. Such inaccessible data may be content embedded within the visible components or controls. For example, an application may have data stored or displayed in a hierarchical structure such as a tree, a system of folders, or other hierarchical mechanism. When using the application, each item in the hierarchical structure can itself be expanded or collapsed. For example, items in a folder may be depicted on the application when the folder is selected by a user. Similarly, nodes in a tree may be expanded or collapsed. When expanded, each item in the hierarchical structure may display items that are subordinate to or subcomponents of the item that is expanded. Such items will only be shown in a screenshot should the particular item be expanded. The hidden, or collapsed, items that may provide useful information not present in the screenshot. To capture more of the information in the hierarchical structure, multiple screenshots of different expanded items would be required. Similarly, an application may include a window having inaccessible data that is simply not currently visible on display. The user would scroll up, down, or sideways to view the inaccessible data. Such inaccessible data are hidden from view and thus not captured in a single screenshot. Instead, multiple screenshots in which different portions of the window are visible may be required. Note that the inaccessible data as used herein is distinct from data which not renderable for certain users with disabilities.

Another issue with screenshots arises when different views are linked together in the application. As users select items in a first view, a second view may be desired to display the relevant properties of the selected item. In a screenshot, only the properties of the selected item at the time the screenshot was taken would be available. To view other properties of a different but possibly related object, one would need to select that object, and then capture the contents of the screen once again, hoping to include all relevant portions of both views.

Screenshots may also be inaccessible to those with visual impairments. To the blind or visually-impaired person using a screen-reader, the screenshot is, at best, taken to be an image with a short description, assuming a description was provided by the author. Thus, the pedagogical and diagnostic role of the screenshot may be completely void for the blind user or for someone who relies upon screen-reading assistive technology. Although other solutions exist for obtaining the information captured by a screenshot, such solutions rely on printing a description of the structure of the user interface as a text file. However, for large user interface elements having multiple components, the resulting text file may be large and complex. The resulting textual representation may be very difficult to consume and, when taken together with the properties of all of the components, nearly unreadable. Thus, while the resulting set of information is capable of capturing all visible and hidden componentry, it is unmanageable and not readily consumable to the average user.

What is needed is an improved mechanism for capturing the run time state of an application.

### BRIEF SUMMARY

Exemplary embodiments disclose a method and system for providing a runtime state of an application on a user interface. The method and system include rendering a user interface element on the user interface in response to a request for a capture of the runtime state of the application. The method and system also include generating control code for managing a response of the user interface element to the user action. The user interface element corresponds to the runtime state and to data including at least one of control data and inaccessible data. The control data corresponds to control of the user interface element. The inaccessible data corresponds to a portion of the user interface element not depicted on the user interface for the capture.

### BRIEF DESCRIPTION OF THE DRAWINGS

FIGS. 1A and 1B are a logical block diagrams illustrating an exemplary system environment in which one embodiment for capturing a runtime state of an application.

FIG. 2 is a diagram illustrating a process for capturing the runtime state of an application in accordance with an exemplary embodiment.

FIG. 3 is a diagram illustrating another process for capturing the runtime state of an application in accordance with an exemplary embodiment.

FIGS. 4A-4D is a diagram illustrating another process for capturing the runtime state of an application in accordance with another exemplary embodiment.

### DETAILED DESCRIPTION

The present invention relates to methods and systems for capturing the runtime state of a user interface corresponding to an application. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

As will be appreciated by one of ordinary skill in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The exemplary embodiments provide methods and systems for capturing the runtime state of an application on a user interface. The method and system include rendering a user interface element on the user interface in response to a request for a capture of the runtime state of the application. The method and system also include generating control code for managing a response of the user interface element to the user action. The user interface element corresponds to the runtime state and to data including at least one of control data and inaccessible data. The control data corresponds to control of the user interface element. The inaccessible data corresponds to a portion of the user interface element not depicted on the user interface for the capture. As part of the capture of the runtime state, inaccessible data and/or control data may also be captured. This provides access to data not otherwise shown. For example, a user may scroll up or down to a hidden portion of the window—thus revealing inaccessible data that would otherwise be hidden. Similarly, nodes in a hierarchical or tabular structure can be expanded to reveal inaccessible data therein. Thus, a user may navigate through the screenshot.

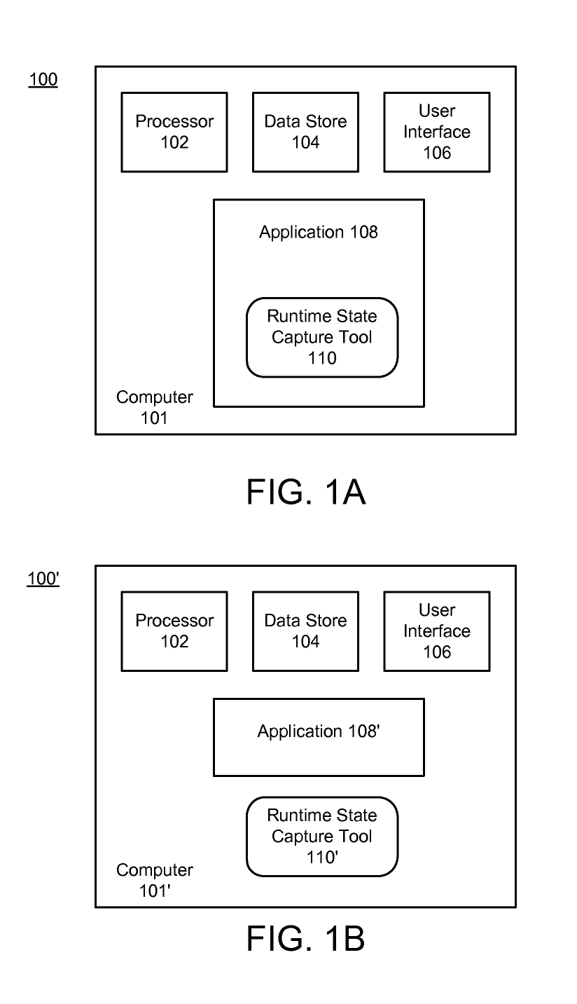

FIG. 1A is a logical block diagram illustrating an exemplary system environment for implementing one embodiment of a system that can capture the runtime state of an application. The system 100 may include a computer 101. The computer 101 may exist in various forms, including a personal computer (PC), (e.g., desktop, laptop, or notebook), a mobile phone, a personal digital assistant (PDA), a set-top box, a game system, and the like. The computer 101 may include components of typical computing devices, including a processor 102, input devices (e.g., keyboard, pointing device, microphone for voice commands, buttons, touchscreen, etc.), output devices (e.g., a display device on which user interface 106 is provided). The computer 101 may further include computer-readable media, e.g., memory and storage devices 104 (e.g., flash memory, hard drive, optical disk drive, magnetic disk drive, and the like) containing computer instructions that implement an embodiment of a runtime state capture tool 110 when executed by the processor 101. In the embodiment shown, the system 101 resides entirely on the computer 101. However, in another embodiment, the system 101 may include server(s) and one or more client computers that communicate with the server over a network. In such an embodiment, different components may reside on the server(s) and client computers.

Application 108 is executed on the processor 102 and displayed on the user interface 106. A runtime state capture tool 110 is used to capture the runtime state of the application 108. In the embodiment shown, the runtime state capture tool 110 is implemented as part of the application 108. In response to a user request to capture the runtime state of the application 108, the user interface elements of the application currently provided on the user interface 106 are captured. In addition to data explicitly depicted on the user interface 106, inaccessible data and/or control data may also be captured. Inaccessible data include data related to the user interface elements of the runtime state which are not shown. For example, data in a hierarchical structure, a tabular format, or data not currently shown in a corresponding window of the user interface 106 may be captured. Control data corresponds to how the user interface elements may be controlled. For example, control data may include how nodes in a hierarchical and/or tabular structure are expanded or collapsed, how a window may be scrolled through, links to other aspects of the runtime state of the application 108, and/or other ways in which the user interface elements corresponding to the runtime state of the application 108 respond to user requests.

In most embodiments, the runtime state capture tool 110 is implemented with an or in conjunction with applications using a model-view-controller (MVC) architecture. In some such embodiments, dynamic HTML (DHTML) technology may be employed. The DHTML technologies use HTML or CSS to generate the view and JavaScript to generate the controller. In such embodiments, the model may include collapsed and/or control data corresponding to the application 108. The data captured may be taken directly from the application 108. In addition, a developer or other user of the screen shot 110 may supplement the data, for example to improve accessibility through assistive technologies. The view may include code for generating HTML and/or CSS that render one or more user interface elements via the user interface 106. The controller may be generated using JavaScript. The controller manages control data and the response of the user interface elements to user requests. The controller may also link different views of the application provided via the runtime state capture tool 110 and perform other management functions. The controller may also comply with W3C Web Accessibility Initiative Accessible Rich Internet Application (WAI-ARIA) standards to improve accessibility of the captured content. Thus, the user interface elements provided by the runtime state capture tool 110 correspond to the runtime state of the application 108 and may mimic the look, feel, and function of the application 108. Further, the user interface elements may be updated, through the data and controller, in response to user actions.

FIG. 1B is a logical block diagram illustrating an exemplary system environment for implementing one embodiment of a system that can capture the runtime state of an application. The system 100′ may be analogous to the system 100. For example, a computer 101′, processor 102′, data store 104′, user interface 106′, application 108′, and runtime state capture tool 110′ may be analogous to the computer 101, processor 102, data store 104, user interface 106, application 108, and runtime state capture too. 110, respectively. However, the runtime state capture tool 110′ is a separate component from the application 108′. As such, the runtime state capture tool 110′ may be usable on the multiple applications 108′. However, the user of the runtime state capture tool 110′ may add additional data in order to manage the user interface elements as desired.

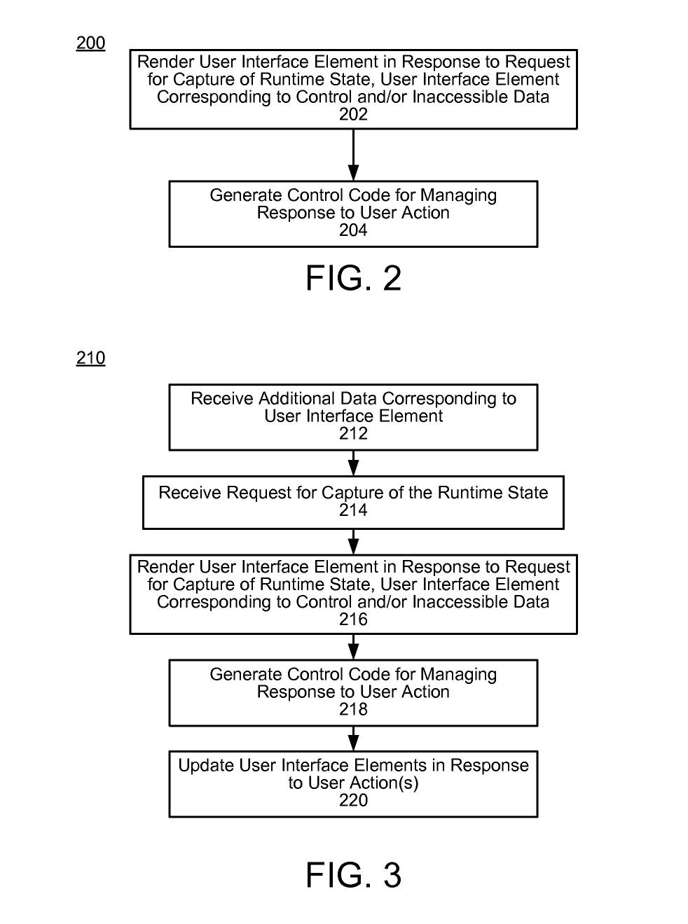

FIG. 2 is a diagram illustrating a process 200 for capturing the runtime state of an application in accordance with an exemplary embodiment. The process 200 is described in the context of the system 100. More specifically, the runtime state capture tool 110 may be used to implement the process 200. The runtime state of the application 108 includes one or more user interface elements depicted on the user interface 106, or display.

In response to a request for a capture of the runtime state of the application 108, the runtime state capture tool renders user interface elements on the user interface 106, via step 202. Step 202 may be accomplished by generating HTML and/or CSS that render user interface elements which provide a look and feel of the runtime state of the application 108. The user interface elements thus correspond to the runtime state of the application 108 at the time of capture. The user interface elements may also correspond to control data and/or inaccessible data for the application 108. Control data relates to how the user interface elements may respond to a user interaction, such as navigation by a user. For example, if the user interface elements include hierarchical structures such as trees or a system of folders, the control data may correspond to nodes of the trees and folders and indicate how such nodes and folders are to be expanded or collapsed. The control data may also include another mechanism for accessing specific portions of the user interface elements that are hidden from view. Rendering the user interface elements may also include generating controls corresponding to the control data. For example, the nodes and folders in hierarchical structures may be generated. The controls may be selected by a user to navigate to other data, other user interface elements, or other portions of the window that are not initially depicted. The inaccessible data may include data not explicitly depicted on the user interface 106 at the time of the capture. Such inaccessible data may include portions of user interface element(s) in a hidden portion of a window or collapsed in a node of a tree. The rendering in step 202 may include storing the relevant control, collapsed and other data for the application corresponding to the user interface elements. In some embodiments, a subset of the collapsed and control data available to the application 108 is used in step 202.

Control code for managing a response of the user interface elements to the user action is generated, via step 204. Step 204 may include generating JavaScript code used to manage navigation of the user interface elements. More specifically, the control code is generated using the control data described in connection with step 202. The control code may set the initial properties and otherwise manage the state of controls, such as nodes, in the user interface elements rendered in step 202. For example, the code may manage how the user interface elements respond to a user action, such as selection of a particular node or other control. Thus, the control code may manage when nodes are expanded or collapsed, whether items corresponding to the nodes are visible, what is rendered in response to the user scrolling through a window, and how user interface elements may otherwise be navigated. The control code may also be used to link related user interface elements, some of which may not be initially rendered. Thus, the control code may link the control codes and other portions of the user interface elements rendered in step 202 to the data for the application 108.

Using the method 200, the runtime state of the application 108 may be captured. The capture depicts the runtime state of the application 108 as currently provided via the user interface 106. To that extent, the method 200 is analogous to a method for providing screenshots. However, the method 200 provides additional advantages. The method 200 provides access to inaccessible data that is not explicitly depicted at the time of capture and that corresponds to the user interface elements. The user may be able to access this inaccessible data by navigating through the user interface elements. For example, inaccessible data corresponding to portions of a window for the application 108 that are hidden at the time the runtime state are captured. The user may be able to scroll to the hidden portion of the window to view the inaccessible data. Similarly, inaccessible data may be hidden and only represented by a hierarchical structure, such as a tree. The inaccessible data may be accessed by selecting nodes or other features of the hierarchical structure. Stated differently, a user may be able to navigate through the user interface elements initially shown to access other data that is part of the runtime state of the application 108. Consequently, the captured runtime state rendered in step 202 provides additional information to the user that is not readily available when the runtime state is captured using another mechanism. The user interface elements rendered in step 202 may also be linked to other user interface elements or views not initially rendered. A fuller picture of the runtime state of the application may thus be provided. Further, as additional data may be included in the capture of the runtime state, more information related to the runtime state may be provided to accessibility tools. The information provided may be compatible with WAI-ARIA or other standards. Consequently, the captured runtime state may be more accessible to assistive technologies.

FIG. 3 is a diagram illustrating another process 210 for capturing the runtime state of an application in accordance with an exemplary embodiment. The process 210 is described in the context of the systems 100/100′. More specifically, the runtime state capture tool 110/110′ may be used to implement the process 210. The runtime state of the application 108/108′ includes one or more user interface elements depicted on the user interface 106, or display.

When developing the application 108/108′ and/or tool 110/110′, the developer or other user may provide additional data corresponding to particular user interface elements, via step 212. For example, the developer or other user may provide alternative text, descriptions of particular graphic user elements, and/or other text. The data provided in step 212 may aid in ensuring that the capture of the runtime state is accessible to assistive technologies. The additional data provided by the user may be utilized to augment the data already present in the application 108/108′ in filling in the user interface elements.

A request for a capture of the runtime state of the application 108/108′ is received by the computer 101/101′, via step 214. The request for capture may be made by the developer, and end user, another application, and/or other entity. In response to the request, the runtime state capture tool 110/110′ renders user interface elements on the user interface 106/106′, via step 216. Step 216 is analogous to step 202 of the method 200. Control code for managing a response of the user interface elements to the user action is generated, via step 218. Step 218 is analogous to step 204 of the method 200. Thus, the runtime state of the application 108/108′ may be captured.

Once the runtime state is captured, a user may desire to navigate through the state to investigate different aspects of the application 108/108′. Thus, in response to user action(s), one or more of the user interface elements may be updated, via step 220. In some embodiments, step 220 may include generating new user interface element(s) not previously depicted. Inaccessible data may be shown, for example by expanding nodes or scrolling to previously hidden data.

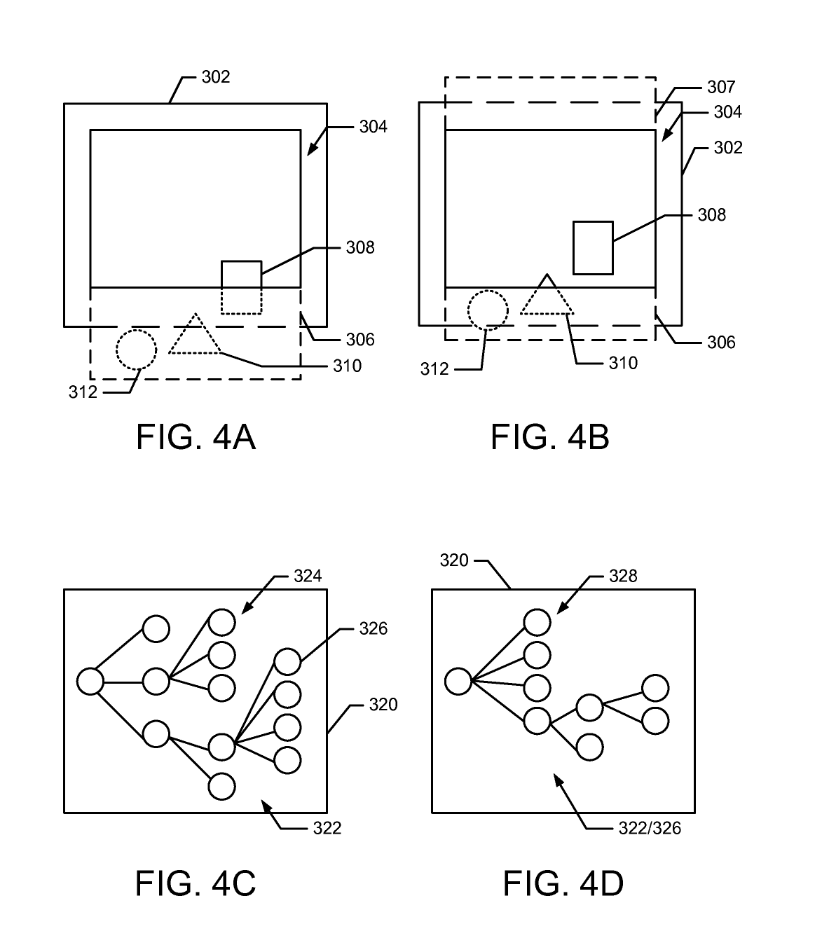

For example, FIGS. 4A-4D depict examples of user interfaces 302 and 320 providing the runtime state of an application 108/108′. FIG. 4A depicts a user interface 302, such as a display. The runtime state of the application 108/108′ is captured in user interface elements 304, 308, 310, and 312. Steps 212, 214, 216, and 218 may thus have been performed to render the user interface elements 304, 308, 310, and 312. The user interface element 304 is a window, only a portion of which is actually depicted on the user interface 302. The portion 306 of the user interface element 304 is not shown on the display 302. The user interface elements 308, 310, and 312 could include graphics, hierarchical structures, text, or other elements. As initially shown in FIG. 4A, a portion of element 308 is shown. However, user interface elements 310 and 312, as well as a remaining portion of user interface element 308 are not visible. FIG. 4B depicts the user runtime state of the application 108/108′ after user interface element 304 has been updated in response to a user action, as in step 220. In particular, the user has opted to scroll down the window/user interface element 304. Portions 306 and 307 of the user interface element 304 are now hidden. Because the user has scrolled down sufficiently far, user interface element 308 is now completely visible. A portion of user interface element 310 is also shown. However, user interface element 312 and a portion of the user interface element 310 are still not visible to a user.

FIG. 4C depicts another user interface 320, such as a display. The runtime state of the application 108/108′ is captured in hierarchical structure 322 that may be considered to include multiple user interface elements. Steps 212, 214, 216, and 218 may thus have been performed to render the user interface elements 322. In particular, nodes 324 are shown. A particular node 326 is also indicated. The nodes 324 and 326 may be considered to be controls corresponding to control data for the application 108/108′. FIG. 4D depicts the user interface/display 320 after the user interface elements 322 have been updated in response to a user action. The user has opted to expand the node 326. Thus, the inaccessible data corresponding to the node 326 has been expanded. In the embodiment shown, the inaccessible data includes another tree. As the node 326 is part of the hierarchical structure 322, FIG. 4D may also be considered to depict the hierarchical structure 322. This portion of the hierarchical structure 322/326 includes nodes 328 that were not depicted in the initial view of FIG. 4C. Thus, inaccessible data may be shown. Different aspects of data stored hierarchically in the application 108/108′ may thus be viewed.

Using the method 210, the runtime state of the application 108/108′ may be captured. The capture depicts the runtime state of the application 108/108′ as currently provided via the user interface 106/106′. To that extent, the method 210 is analogous to a method for providing screenshots. The method 210 is also analogous to the method 200 and, therefore, shares the benefits of the method 200. A fuller picture of the runtime state of the application 108/108′ may thus be provided. Further, as additional data may be included in the capture of the runtime state, more information related to the runtime state may be accessible through the capture and provided to accessibility tools. The information provided may be compatible with WAI-ARIA or other standards. Consequently, the captured runtime state may be more accessible to assistive technologies.

A system and method for capturing the runtime states of an application have been disclosed. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for providing a runtime state of an application on a user interface, comprising:
rendering a user interface element on the user interface in response to a request for a capture of the runtime state of the application, the user interface element corresponding to the runtime state and to data including at least one of control data and inaccessible data, the control data corresponding to control of the user interface element, the inaccessible data corresponding to a portion of the user interface element not depicted on the user interface for the capture; and
generating control code for managing a response of the user interface element to the user action.

2. The method of claim 1 further comprising:
updating the user interface element on the user interface using the inaccessible data and in response to the user action.

3. The method of claim 2 wherein the user interface element includes a window, wherein the inaccessible data includes data depicted in a hidden portion of the window, wherein the user action includes scrolling to the hidden portion of the window, and wherein the updating further includes:
rendering the inaccessible data in the hidden portion of the window.

4. The method of claim 1 wherein the step of rendering further includes:
generating at least one control corresponding to the control data.

5. The method of claim 4 wherein the control code manages the response of the user interface to the user action based on the at least one control.

6. The method of claim 4 wherein the control code sets initial properties of portions of the user interface element, manages navigation based on the at least one control of user interface element, and links the user interface element to a related user interface element.

7. The method of claim 4 wherein the user interface element includes at least one of a tabular element and a hierarchical element, the at least one of the tabular element and the hierarchical element including a node corresponding to the at least one control and wherein at least a portion of the inaccessible data corresponds to the node.

8. The method of claim 7 wherein the user action includes selecting the node and wherein the method further includes:
rendering the at least the portion of the inaccessible data corresponding to the node.

9. The method of claim 8 wherein the at least the portion of the inaccessible data includes an additional control.

10. The method of claim 1 further comprising:
receiving additional data corresponding to the user interface element from a user.

11. The method of claim 10 wherein the step of rendering further includes:
rendering the additional data.

12. A computer program product for capturing a runtime state of an application on a user interface, the computer program product comprising:
a computer readable storage medium;
first program instructions for rendering a user interface element on the user interface in response to a request for a capture of the runtime state of the application, the user interface element corresponding to the runtime state and to data including at least one of control data and inaccessible data, the control data corresponding to control of the user interface element, the inaccessible data corresponding to a portion of the user interface element not depicted on the user interface for the capture; and
second program instructions for generating code for managing a response of the user interface element based on the user action;
wherein the first and second program instructions are stored on the computer readable storage medium.

13. The computer program product of claim 12 further comprising:
third instructions for updating the user interface element on the user interface using the inaccessible data and in response to the user action;
wherein the third program instructions are stored on the computer readable storage medium.

14. The computer program product of claim 13 wherein the user interface element includes a window, wherein the inaccessible data includes data depicted in a hidden portion of the window, wherein the user action includes scrolling to the hidden portion of the window, and wherein the third program instructions further include:
rendering the inaccessible data in the hidden portion of the window.

15. The computer program product of claim 12 wherein first instructions further generate at least one control corresponding to the control data.

16. The computer program product of claim 15 wherein the control code manages the response of the user interface to the user action based on the at least one control.

17. The computer program product of claim 15 wherein the control code sets initial properties of portions of the user interface element, manages navigation of the at least one control of user interface element, and links the user interface element to any related user interface element.

18. The computer program product of claim 15 wherein the user interface element includes at least one of a tabular element and a hierarchical element, the at least one of the tabular element and the hierarchical element including a node corresponding to the at least one control and wherein at least a portion of the inaccessible data corresponds to the node.

19. The computer program product of claim 18 wherein the user action includes selecting the node and wherein the computer program product further includes
fourth instructions for rendering the at least the portion of the inaccessible data corresponding to the node;
wherein the fourth instructions are stored on the computer readable medium.

20. The computer program product of claim 19 wherein the at least the portion of the inaccessible data includes an additional control.

21. A system comprising:
a computer processor;
a user interface;
an application executing on the computer processor and having a runtime state, the application configured to:
render a user interface element on the user interface in response to a request for a capture of the runtime state of the application, the user interface element corresponding to the runtime state and to data including at least one of control data and inaccessible data, the control data corresponding to control of the user interface element, the inaccessible data corresponding to a portion of the user interface element not depicted on the user interface for the capture; and
generate control code for managing a response of the user interface element to the user action.

22. The system of claim 21 wherein the application is further configured to update the user interface element on the user interface using the inaccessible data and in response to the user action.

23. The system of claim 21 wherein the application is configured to render the user interface element to generate at least one control corresponding to the control data.

24. The system of claim 23 wherein the control code manages the response of the user interface to the user action based on the at least one control.

25. A system comprising:
a computer processor;
a user interface;
an application executing on the computer processor and having a runtime state; and
a tool for capturing the runtime state of the application, the tool being configured to:
render a user interface element on the user interface in response to a request for a capture of the runtime state of the application, the user interface element corresponding to the runtime state and to data including at least one of control data and inaccessible data, the control data corresponding to control of the user interface element, the inaccessible data corresponding to a portion of the user interface element not depicted on the user interface for the capture; and
generate control code for managing a response of the user interface element to the user action.
